(19) United States
(12) Patent Application Publication
(10) Pub. No.: US 2012/0296638 A1
(43) Pub. Date: Nov. 22, 2012

(54) METHOD AND SYSTEM FOR QUICKLY RECOGNIZING AND RESPONDING TO USER INTENTS AND QUESTIONS FROM NATURAL LANGUAGE INPUT USING INTELLIGENT HIERARCHICAL PROCESSING AND PERSONALIZED ADAPTIVE SEMANTIC INTERFACE

(76) Inventor: Ashish Patwa, Port Barrington, IL (US)

(21) Appl. No.: 13/475,908

(22) Filed: May 18, 2012

Related U.S. Application Data
(63) Continuation of application No. 10/116,870, filed on Apr. 5, 2002, now abandoned.

(51) Int. Cl. G06F 17/27; G10L 15/00

(52) U.S. Cl. 704/9; 704/236; 704/E15.001

(57) ABSTRACT

In embodiments of the present invention, capabilities are described for understanding and responding to the user intent and questions quickly wherein the understanding is based on supervised system learning, Intelligent layered semantic and syntactic information processing and personalized adaptive semantic interface. Supervised system learning creates reference pattern set for the intent repository and possible question categories. Each layer in the layered processing increases the probability of the intent/question recognition. Personalized adaptive voice interface learns from user's interactions over time by enriching the pattern sets and personal index for successfully resolved user intents and questions. Collectively, all these technologies improve the response time for correctly recognizing and responding to user's intents and questions.

### CROSS REFERENCE TO RELATED APPLICATIONS

Continuation of application No. 10116870 filed on May 18, 2011. The application claims benefit of U.S. Provisional Patent Application No. 10116870, filed May 18, 2011, and entitled “Device independent Semantic technologies-enabled Intelligent Virtual Personal Digital Assistant”, which is hereby incorporated herein by reference.

### TECHNICAL FIELD

This description relates to techniques for developing the semantic technologies based intelligence used by virtual personal digital assistant for interpreting and responding to user's voice instructions quickly.

### FIELD OF THE INVENTION

The present invention relates generally to Device independent Semantic technologies-enabled Intelligent Virtual Personal Digital Assistant and more particularly to its ability to recognize user intent from voice instructions quickly, automatically prepare a response for user queries and constantly learn and adapt to user expressions over time.

For the past few years, the use of smartphones have been growing at a phenomenal rate. Most smartphones support voice recognition. However, most of the phones support very limited voice functions so far.

Also, a few companies have already developed intelligent personal digital assistant software. Typically, these softwares allow users to accomplish some basic tasks such as calling a friend, text, email etc. with voice commands. Before using such software, the user has to get familiar with the supported commands.

One way to attempt to get around this limitation is to include an intelligent voice-recognition capability in the assistant that accepts natural language input, uses it to quickly understand user's intent and responds with appropriate content or action. It should also be capable of answering user's questions.

Supporting natural language conversation poses certain challenges. Humans can express an intent or idea in so many different ways. For example, to check local weather, one can ask in many different ways. One may ask “How's the weather?”, “What's the forecast for this morning?”, “Do I need an umbrella?”, “How windy is it out there?” Clearly, basic voice recognition alone is not sufficient to resolve the different ways of expression and retrieve weather information.

Another issue with developing such system is that it should be smart enough to use the correct context to present the required information. For example, to answer the question “What's the forecast this morning?” the system should know the location of the user and prepare the weather report accordingly.

In summary, to make sure the system understands the user intent, collects required context to prepare the response and processes the information to provide an accurate answer, the system has to go through a lot of information and a lengthy analytical process. Also, as mentioned before, an expression for a particular intent may vary from user to user. If a system can adapt to user expressions and can use some intelligence to effectively use the intent recognition process, the response time to user queries can be very fast.

### SUMMARY OF INVENTION

The present invention provides intelligence to virtual personal digital assistant softwares to quickly process and respond to user's intents and questions from voice input and to make system learn about user's expressions for different intents so that it can process and respond to them more effectively over time.

In processing, the NLP Engine can analyze the expression grammatically and semantically to transform at least a part of the expression into at least one intent or question interpretation and related set of required and optional predicates or generate a prompt to receive additional information from the user.

The intent can be a search for a particular local business, query for the current weather etc. The intent can depend on the context under which the person made the expression. The question can be any general query such as “Who is the president of the United States?”

In one embodiment, the method includes Intent Learner, which upon successful fulfillment of the intent, records interpreted user expression along with other necessary information in Personal Index to help system learn about that particular user's expressions for different intents over time and adapt itself to recognize and resolve them faster. Domain indices are prepared by training the system for domain specific possible general user expressions, keywords etc.

In another embodiment, the system uses hierarchical processing of the voice input. Each layer uses unique capabilities and techniques to extract meaning from the input and generates confidence metric. This metric is compared against the benchmarks created for each intent while training the system and if the metric is found satisfactory, intent recognition phase completes and the rest of the layers are ignored. Otherwise, the system passes the top ranked intents to the next layer. Each layer increases the probability of intent recognition and minimizes the workload for the next set of processing layers. This technique helps optimize the response time.

In addition to the NLP Engine, the personal assistant software can also include other components as suggested in FIG. 2 to personalize offerings to the user.

Other aspects and advantages of the present invention will become apparent from the following detailed description, which, when taken in conjunction with the accompanying drawings, illustrates by way of example the principles of the invention.

### BRIEF DESCRIPTION OF THE DRAWINGS

The present invention will be readily understood by the following detailed description in conjunction with the accompanying drawings, wherein like reference numerals designate like structural elements, in which:

FIG. 1 is a block diagram of the intent resolution infrastructure and possible workflow according to one embodiment of the invention

FIG. 2 is a block diagram of the Intelligent Virtual Personal Digital Assistant that uses the capability described in this invention

FIG. 3 illustrates the functional workflow of Intent Learner according to one embodiment of the invention

FIG. 4 illustrates the layered approach used for voice input processing or intent recognition workflow to generate quick response according to one embodiment of the invention

FIGS. 5, 6 and 7 illustrate different phases of the intent recognition workflow

FIG. 8 illustrates intent resolution workflow

FIG. 9 illustrates Question resolution workflow

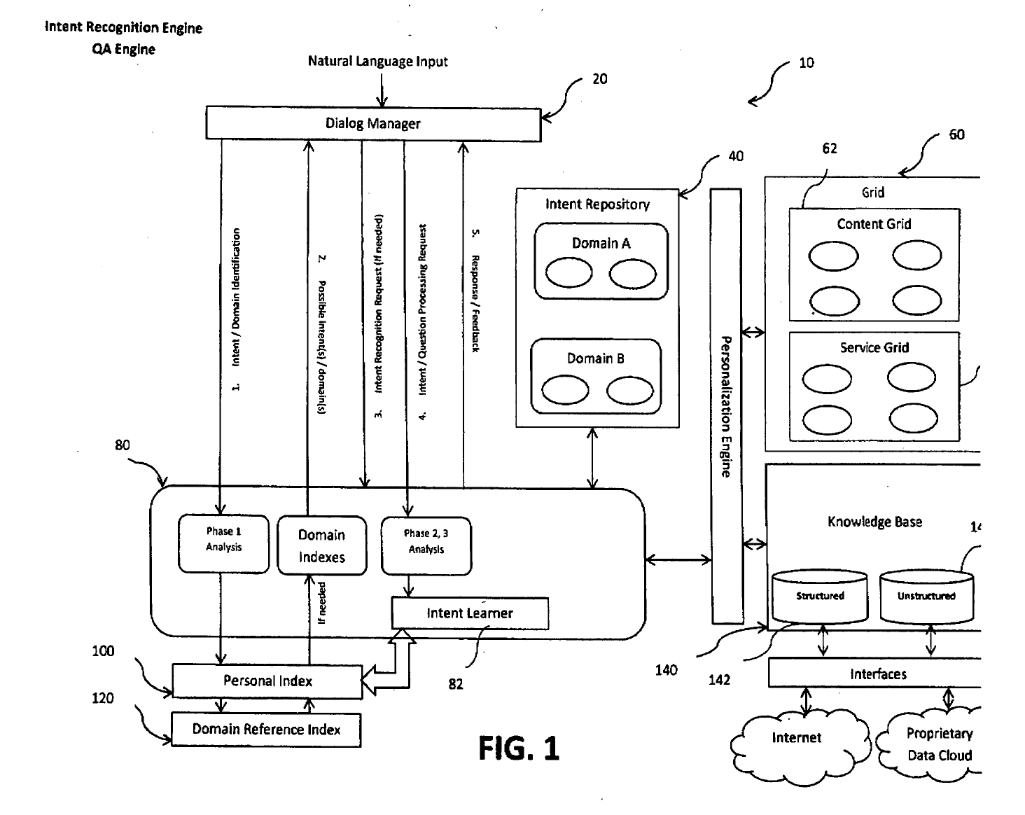

### DETAILED DESCRIPTION OF PREFERRED EMBODIMENTS

The present invention relates to understanding user intent and questions from voice actions, automatically preparing responses and learning to adapt the system to user's expressions over time for quick and effective responses.

In the following detailed description, reference is made to the accompanying drawing figures which form a part hereof, and which show by way of illustration specific embodiments of the invention. It is to be understood by those of ordinary skill in this technological field that other embodiments may be utilized as well as procedural changes may be made without departing from the scope of the present invention.

One embodiment of the invention includes a semantic technologies enabled, Adaptive User Intent Recognition and Resolution Engine 10. In the following description, the engine mainly uses English language; however, the invention can also be applicable to recognizing user intents in other languages.

The Intent Recognition and Resolution Engine comprises of:

Dialog Manager 20—Facilitates conversation with the user

Intent Repository 40—Stores known Intents for all supported domains. It is generated during the system training process. Some of the categories of the intents are Navigational, Informational, Transactional For example, “Check Weather Forecast” is one of the intents in Weather domain and it is of Informational type.

Personal Index 100—Maintains semantic analysis of successfully recognized intents and questions

Smart Index—Index of most frequently used intents and question categories. Subset of Personal Index, resides in memory to facilitate quick decision making

Domain Reference Index 120—Each functional domain consists of a cluster of related intents. Some of the examples of function domains are Local Search, Personal Health Planner, Weather etc.

Grid 60—Consists of information and service interfaces (internal and third-party APIs—Application Programming Interfaces). For example, to retrieve real-time weather information, system will use Weather Content Provider such as WeatherBug API.

Knowledge Base 140—includes interfaces to proprietary and open data clouds of structured 142 and unstructured 144 data sources. Some of the examples of structured data sources are FreeBase, DBPedia etc. Unstructured data sources include interfaces to search engines, useful websites on which the agent can run searches and extract information by parsing the result pages

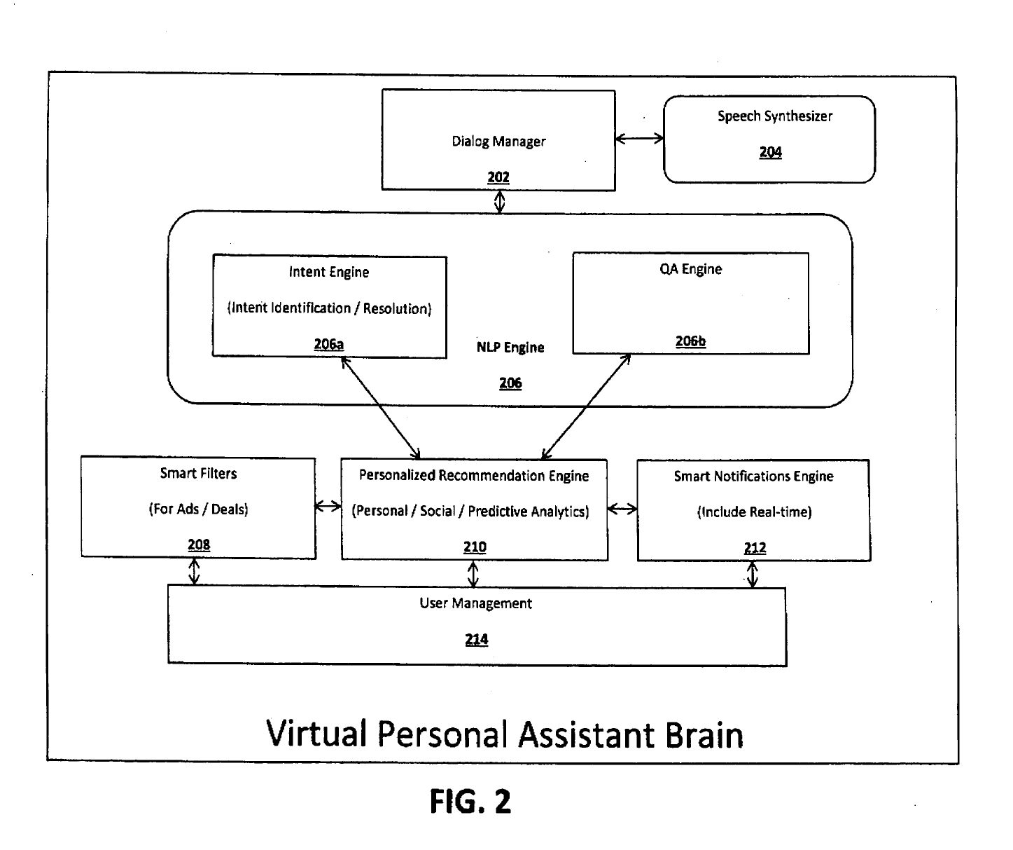

The most important component of the Intent Recognition and Resolution Engine is Intent Learner 82. As suggested in FIG. 2, it updates Personal Index with required semantic components upon successful fulfillment of intents to make system smarter and facilitate faster system response.

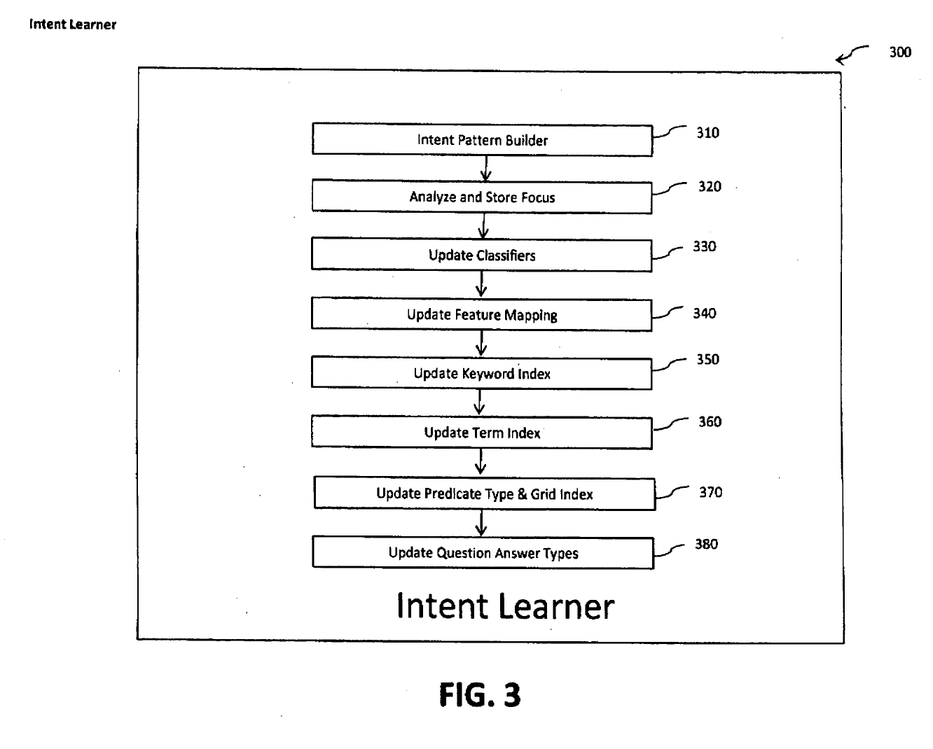

Upon successful fulfillment of any intent, the Intent Learner FIG. 3 makes following changes to the Personal Index 100—

310—Builds a pattern using the recognized entities and semantic/syntactic analysis of the user's expression for the intent and stores it.

320—A focus is a subset of domain and set of closely related intents. Focus is calculated during the semantic analysis of the user's voice input and is stored in Personal Index 100

330—Classifiers are trained during system training and when the intent workflow completes successfully, classification criteria are updated with the recognized intent pattern, semantic analysis and keywords and classifiers are updated.

340—A feature is extracted from the user's input during the semantic analysis. Personal Index maintains mapping of features and related known intents. The mapping is updated to include the new entry. If the entry already exists, its score is updated.

350, 360—Personal index maintains a list of related keywords, terms for all recognized intents. The list is updated to include any new keywords and terms found during the semantic analysis for the newly recognized intent.

370—Each intent may require necessary and/or optional predicates for fulfilling user's request. Predicates are information pieces used to build the context for resolving the intent. For example, to check the weather forecast, one may ask “How's the weather today?” For this expression, the system assumes that the user's intent is to check the weather forecast. As there is no location mentioned in the user expression, the system uses current location and it assumes that the user is asking for today's weather forecast. So, here location and “today” make the context for weather forecast intent. Both are optional predicates as the system uses current location as a default location and searches for today's weather when no time predicate is specified. For some intents such as local search, required predicate can be a business name. For example, “Find restaurant” would make sense but if the user just says “Find”, the system may prompt the user for the required predicate “business name”. All known intents have required and optional predicates identified. Upon successful completion of the intent, the system may store the predicate information to help system learn any new predicate types or categories.

Each predicate is linked to one or more grid components. For example, for the weather forecast intent, location predicate can be linked to the GPS grid component. Upon successful completion of any intent, any new references to grid components are preserved in Personal Index.

During system preparation time, several resources such as TREC (Text REtrieval Conference) documents are used to train the system for possible intent types. During supervised training phase, system also learns about question and related answer types. Once the intent is fulfilled, Intent Learner 82 Will add any new required entries in the index for newly identified question and answer types and/or categories.

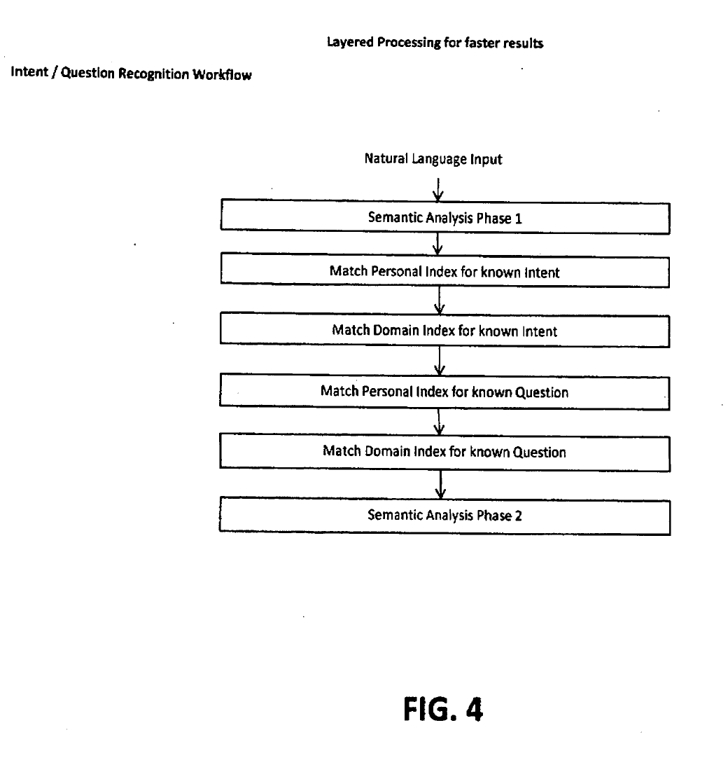

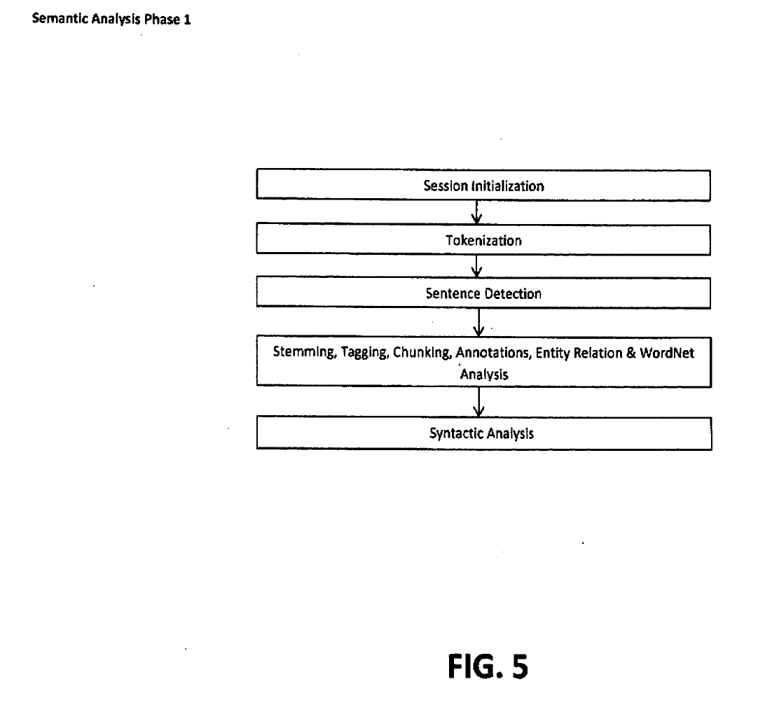

Another embodiment of the invention includes a method that uses hierarchical processing approach FIG. 4 to intelligently process the voice instruction to recognize user intents and queries quickly. Typically, the voice input goes through Phase 1 processing FIG. 5, which includes standard syntactic analysis based on system training. A pattern from the voice input is formed using phase 1 analysis and the pattern is compared against user's Personal Index 100. If similar pattern is found, the required information about the related intent is used to fulfill the intent.

If similar pattern is not found, the domain index 120 is consulted to see if it contains any similar pattern. Domain Index is populated with known intent patterns during system training.

Similar process is followed for recognizing Question patterns

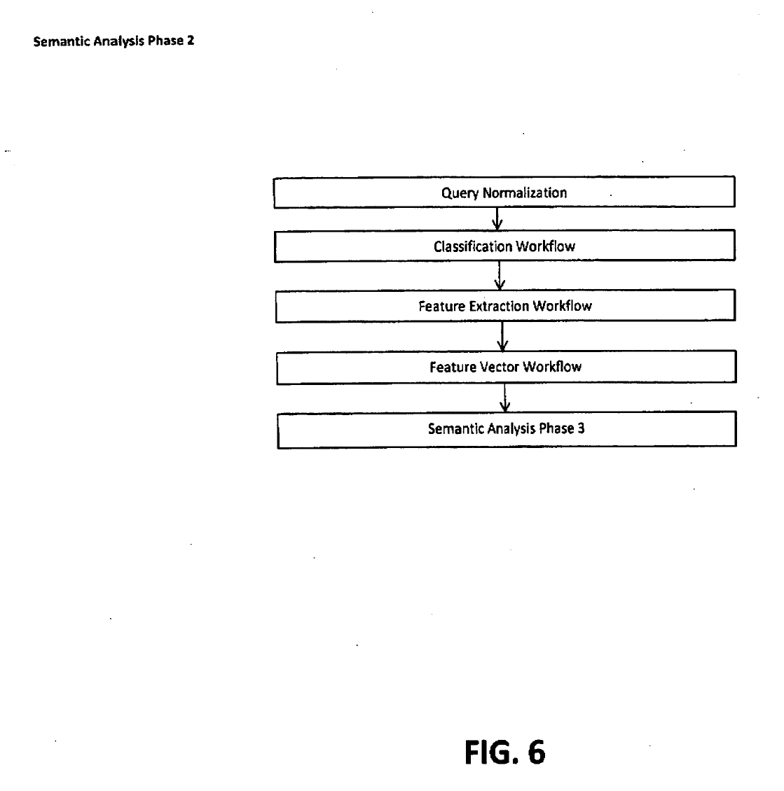

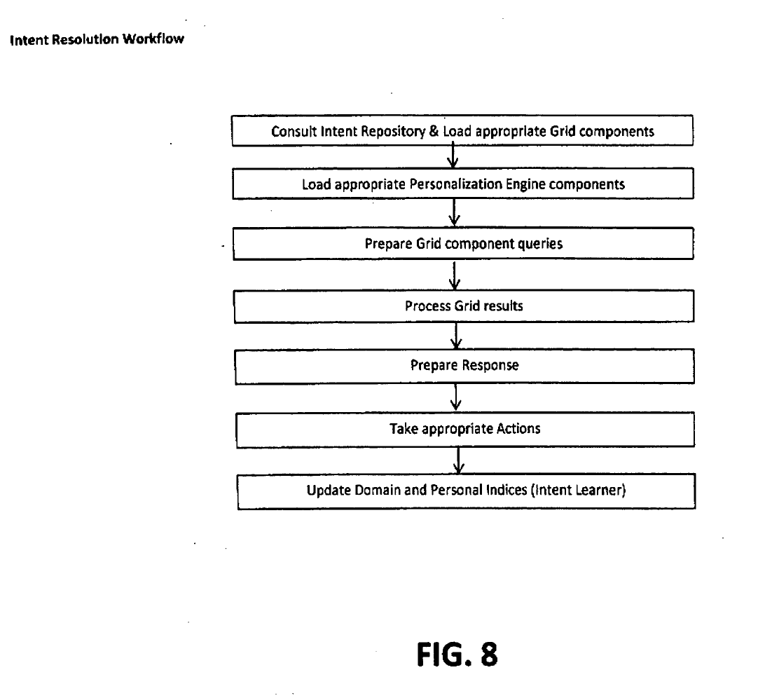

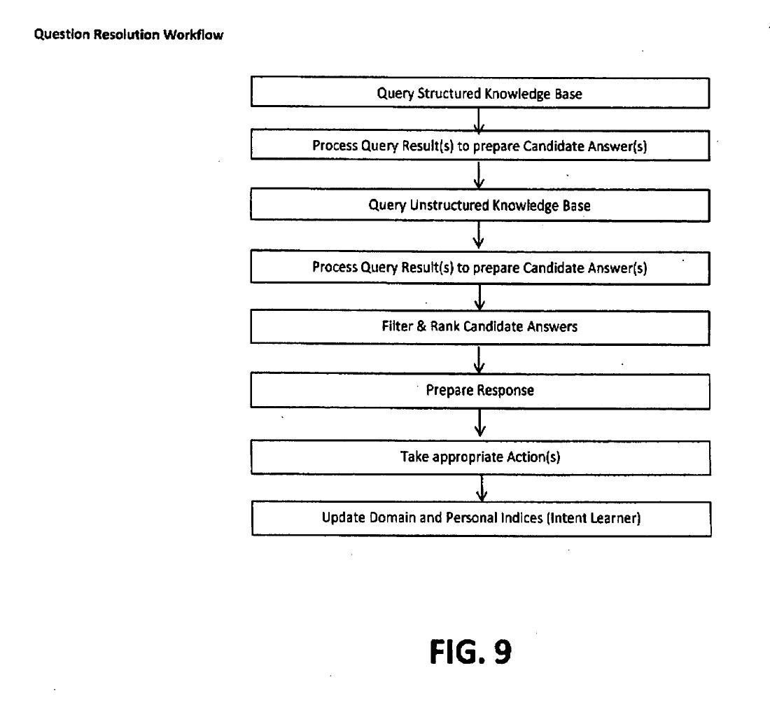

During Phase 2 processing FIG. 6, semantic analysis is performed. The input is run through the classifiers, which are typically prepared during system training. Features and Feature Vectors are processed and compared against the intent repository 40 to find matches. Each layer generates an intent recognition confidence metric, which is compared against the benchmark metrics created during system training. if they match, system assumes the intent is recognized and if all required predicates are also available, it skips rest of the layers and starts intent/question resolution workflow FIG. 8/FIG. 9. Otherwise, based on the analysis, the layer filters certain possibilities and passes the intent possibilities with highest confidence metrics to the next layer.

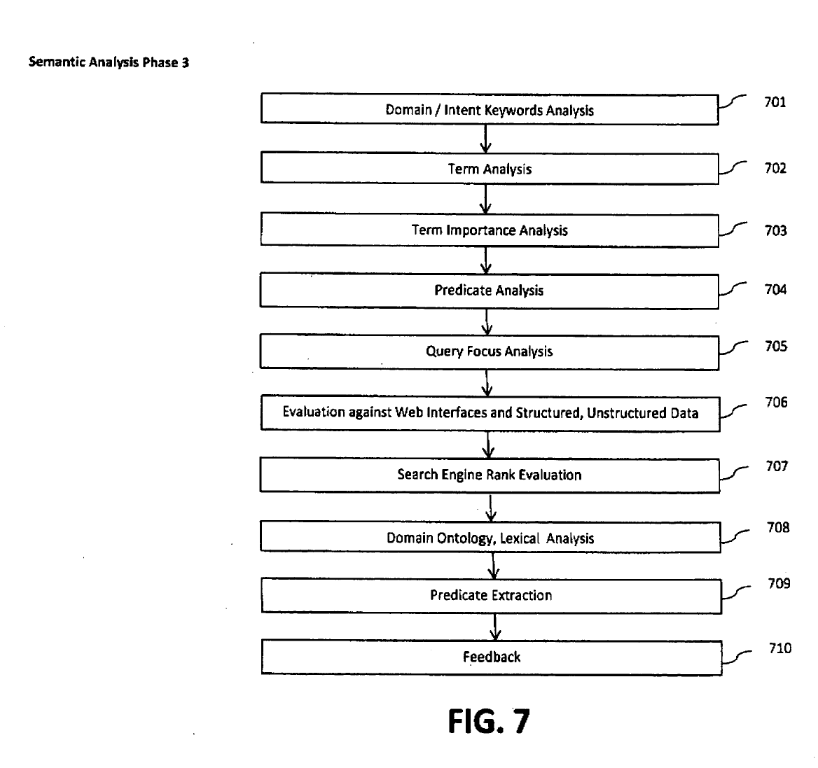

If Phase 1 and Phase 2 fail to recognize the user intent, Phase 3 analytics is performed. During phase 3 analysis FIG. 7, several analytics are performed on the voice input and the semantic and syntactic analysis prepared.

If the keyword 701 and term 702, 703 based analytics fail to recognize the intent, the voice input is run through web search interfaces and the web search analysis is leveraged to decide theme or focus 705 of the query.

The same process is performed on known websites as well as proprietary and open, structured and unstructured data sources 706.

The semantic analysis is run against the domain ontologies and lexical analysis 708 is performed during the last stage. Any recognized predicates are also compared to the intent repository to understand if the set matches any known intent type.

At this stage, any remaining predicates are extracted 709 from the input. Depending on the outcome, either intent/OA resolution workflow is performed or the user is asked 710 for any additional inputs to help system recognize and/or fulfill the intent.

FIG. 8 and FIG. 9 describe the intent and question resolution workflows

What is claimed is:

1. Intent Learner and the method for personalized adaptive semantic interface,
wherein upon successful completion of intent recognition workflow, Intent Learner stores certain semantic information such as pattern of the recognized intent expressions in the personal index
wherein during the intent recognition workflow, the personal and domain indices are consulted first to minimize the response time

2. Layered processing of the voice input for faster system response
wherein a benchmark system is created during system training to generate normalized confidence metrics for each possible intent recognition workflow
wherein at runtime, each layer creates a confidence metric that can be compared to the related benchmark confidence metrics to assess the fulfillment of the intent
wherein based on confidence metrics, each layer filters the possibilities of the known intents to minimize processing for the next layer
wherein upon meeting the confidence metric, system ignores the rest of the layers in the recognition workflow
